(19) United States
(12) Patent Application Publication
(10) Pub. No.: US 2006/0085181 A1
(43) Pub. Date: Apr. 20, 2006

(54) Keyword extraction apparatus and keyword extraction program

(75) Inventors: Noriyuki Komamura, Mishima-shi (JP); Kazuaki Kidokoro, Mishima-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/968,271

(22) Filed: Oct. 20, 2004

(51) Int. Cl. G06F 17/27

(52) U.S. Cl. 704/9

(57) ABSTRACT

An appropriate keyword to characterize a collection of pieces of access history information is extracted without depending on the contents of documents related to the collection. In a keyword extraction apparatus for performing processing of extracting a keyword that characterizes a collection of pieces of access history information with respect to documents, the apparatus includes a keyword acquisition part that acquires a plurality of keywords from among the pieces of access history information constituting the collection, a weighting part that weights the plurality of keywords acquired based on prescribed rule information, and a specific keyword extraction part that extracts a specific keyword from among the plurality of keywords acquired based on the weights assigned to the plurality of keywords, respectively, in the weighting part.

### BACKGROUND OF THE INVENTION

1. Field of the Invention

The present invention relates a technique for extracting, from a collection of pieces of history information on accesses to documents, a characteristic keyword that represents the content of the collection of access history information.

2. Description of the Related Art

In cases where a document access history information group is composed of a certain plurality of collections of information pieces, a technique is required which can extract a characteristic keyword that represents the content of each collection of the access history information.

However, in the past, as a technique for extracting, from a collection of documents, a characteristic keyword by which one can grasp the content of the document collection without the need to look over all the documents constituting that collection, there has been disclosed one that extracts, from the contents of the documents constituting that collection, a keyword that serves to raise discriminability of that collection from other document groups (Japanese patent application laid-open No. 2003-281159).

In the above-mentioned prior art, in order to acquire a keyword from the contents of documents, information extracted therefrom was not sometimes able to be made use of as a keyword for the collection of documents when the documents have noncharacter or nontext contents such as image files, voice files and so on. Therefore, a similar problem will arise even if the above-mentioned prior art is applied to the extraction of a characteristic keyword that represents the content of a collection of pieces of access history information (for example, even if a keyword is acquired from the contents of the documents related to the collection of the access history information of concern).

### SUMMARY OF THE INVENTION

The present invention is intended to obviate the problems as referred to above, and has for its object to extract an appropriate keyword to characterize a collection of pieces of access history information without depending on the contents in documents related to the collection of access history information.

In order to solve the above-mentioned problems, a keyword extraction apparatus according to the present invention is constructed as follows. In the keyword extraction apparatus for performing processing of extracting a keyword that characterizes a collection of pieces of access history information with respect to documents, the apparatus is characterized by comprising: a keyword acquisition part that acquires a plurality of keywords from among the pieces of access history information constituting the collection; a weighting part that weights the plurality of keywords acquired based on prescribed rule information; and a specific keyword extraction part that extracts a specific keyword from among the plurality of keywords acquired based on the weights assigned to the plurality of keywords, respectively, in the weighting part.

Moreover, in the keyword extraction apparatus as constructed above, it is preferred that the weighting part serve to weight the plurality of acquired keywords on the basis of the frequencies of occurrences of the keywords acquired in the pieces of access history information constituting the collection.

A keyword extraction program according to the present invention serves to make a computer execute processing of extracting a keyword that characterizes a collection of pieces of access history information with respect to documents, the program being characterized by making the computer execute: a keyword acquisition step of acquiring a plurality of keywords from among the pieces of access history information constituting the collection; a weighting step of weighting the plurality of keywords acquired based on prescribed rule information; and a specific keyword extraction step of extracting a specific keyword from among the plurality of keywords acquired based on the weights assigned to the plurality of keywords, respectively, in the weighting step.

In the keyword extraction program as constructed above, it is preferred that the weighting step serve to weight the plurality of acquired keywords on the basis of the frequencies of occurrences of the keywords acquired in the pieces of access history information constituting the collection.

In addition, in the keyword extraction program as constructed above, it is preferred that access histories constituting the collection be associated with a plurality of users.

Moreover, the keyword extraction program as constructed above further comprise an extraction reference information setting step of setting an extraction reference for keywords to be extracted, wherein the weighting step can weight the plurality of acquired keywords on the basis of the frequencies of occurrences of the keywords acquired in a range of the pieces of access history information determined based on the set extraction reference information.

Further, in the keyword extraction program as constructed above, it is preferred that the collection of pieces of access history information be constructed based on either of user names, the contents of accesses, and the time point at which the pieces of access history information are generated, and it is also preferred that the weighting step perform weighting based on the keywords acquired in the keyword acquisition step and information on the frequencies of occurrences of the keywords associated with the collection.

Furthermore, in the keyword extraction program as constructed above, the access history information can include information on the contents of uses of the documents, and the weighting step can weight keywords acquired from among pieces of access history information with respect to the documents based on the contents of uses thereof.

Still further, in the keyword extraction program as constructed above, the weighting step is characterized by weighting the plurality of acquired keywords on the basis of the frequencies of occurrences of the keywords acquired in access history information older than the pieces of access history information constituting the collection.

In addition, in the keyword extraction program as constructed above, the program can further comprise a user identification step of identifying a user who is intended to perform keyword extraction, and the weighting step can perform weighting based on the result of identification in the user identification step.

Moreover, in the keyword extraction program as constructed above, it is preferred that the specific keyword extraction step serve to perform keyword extraction in such a manner that the heavier the weights assigned to the plurality of keywords in the weighting step, the higher are the significance levels of the keywords.

Further, in the keyword extraction program as constructed above, the specific keyword extraction step can provide a screen display of the acquired keywords in a ranked order based on the weights assigned to the plurality of keywords, respectively, in the weighting step.

Furthermore, in the keyword extraction program as constructed above, it is preferred that the keyword acquisition step acquire a plurality of keywords from among pieces of access history information constituting the collection by using a morphological analysis.

Still further, in the keyword extraction program as constructed above, it is preferred that the access history information include at least one of attribute information of the documents related to the access history information, information on the titles of the documents, and information on time points at which the documents were accessed, the contents of accesses to the documents, and users who made the accesses.

According to the present invention, it is possible to extract an appropriate keyword to characterize a collection of pieces of access history information without depending on the contents of documents related to the collection of access history information.

### BRIEF DESCRIPTION OF THE DRAWINGS

FIG. 1 is a functional block diagram illustrating the configuration of a keyword extraction apparatus according to an embodiment of the present invention.

FIG. 2 is a view showing an example of document use history information.

FIG. 3 is a view showing an example of document attribute information.

FIG. 4 is a flow chart explaining the flow of processing in the keyword extraction apparatus according to the embodiment of the present invention.

FIG. 5 is a flow chart explaining a keyword acquisition step FIG. 6 is a view showing the content of a frequency list prepared for collections classified according to “contents of works or tasks performed on documents”.

FIG. 7 is a view showing the content of another frequency list prepared for collections classified according to contents of works or tasks different from those of FIG. 6.

FIG. 8 is a view explaining the content of setting in a setting screen.

FIG. 9 is a flow chart showing the flow of processing when the setting is carried out on the setting screen.

FIG. 10 is a flow chart explaining a weighting step (S103) and a specific keyword extraction step (S104).

FIG. 11 is a view explaining the definition of a weighting rule according to user's requests.

FIG. 12 is a view explaining the definition of a weighting rule to weight the pieces of information related to documents based on the methods of use thereof and the methods of access thereto.

FIG. 13 is a view showing an example of the display of a list of extracted significant keywords.

### DESCRIPTION OF THE EMBODIMENT

Hereinafter, a preferred embodiment of the present invention will be described in detail while referring to the accompanying drawings.

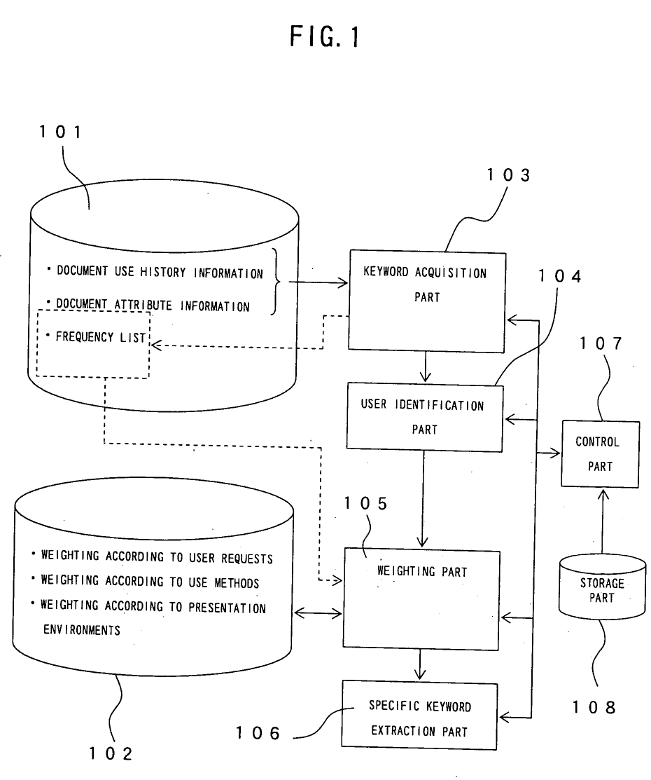

FIG. 1 is a functional block diagram that illustrates the configuration of a keyword extraction apparatus according to an embodiment of the present invention.

The keyword extraction apparatus according to this embodiment is constructed to include a data storage section 101, a rule information storage part 102, a keyword acquisition part 103, a user identification part 104, a weighting part 105, a specific keyword extraction part 106, a control part 107, a storage part 108, and an unillustrated display part.

The data storage part 101 serves to store information related to the use history of documents (document use history information), information related to the attributes of documents (document attribute information), frequency lists (to be described later and so on.

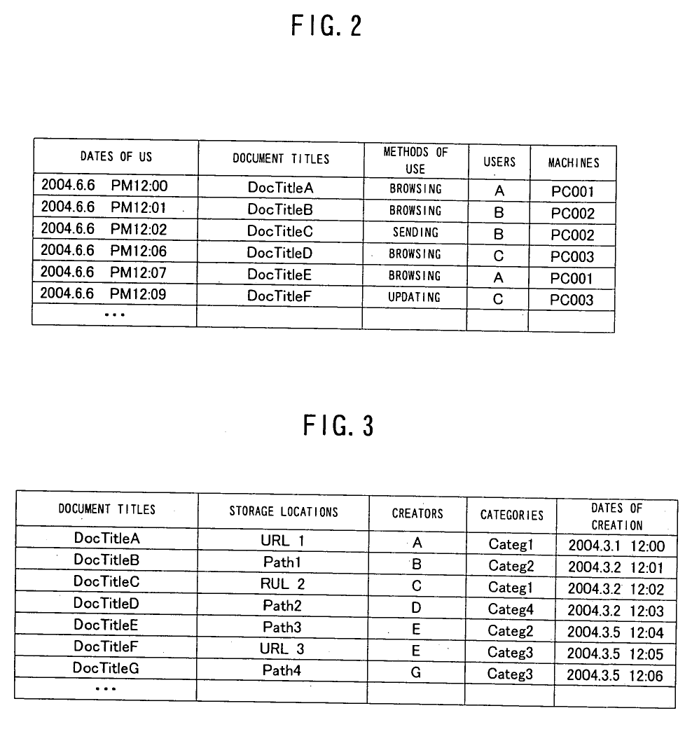

Specifically, the document use history information means information on methods of document use for the documents created by various applications in the case of a user or system using (accessing) the documents, for example, information (history) on who (information on users who made accesses), when (the dates and times of use), from where (the name of a machine used at that time), how (e.g., the content of use of information on operations such as creating, browsing, printing, sending, updating, etc.) the documents are used, etc. One example of the document use history information is illustrated in FIG. 2. In this figure, the example shows the case in which the dates and times of use of the documents, the titles of the documents, the methods of using the documents, the users of the documents, and the names of machines used when the documents are used, are managed as the document use history information.

Then, the document attribute information means a variety of kinds of information attached to the documents used such as information on the attributes of the documents used (dates of creation, creators, storage locations, categories, etc.). One example of the document attribute information is illustrated in FIG. 3. In this figure, the example shows the case in which document titles, storage locations of the documents, document creators, and categories and creation dates and times of the documents are managed as the document attribute information.

Here, note that the document use history information and the document attribute information (corresponding to access history information) constitute a collection (e.g., a group of data classified according to the dates of creation, a group of data stored in a certain folder, a group of data arbitrarily selected, etc.) classified according to prescribed rules (constructed based on either of user names, the contents of accesses, the times at which pieces of access history information were generated). Hereinafter, it is assumed that the keyword extraction processing in this embodiment is carried out with respect to this “collection”.

By combining the above-mentioned document use history information and the above-mentioned document attribute information with each other, it is possible to grasp what kinds of documents were used by who and in what manner. In this regard, note that the document use history information and the document attribute information for a document as stated above may be beforehand fixed (not changed), or may have their contents added and updated in accordance with the occurrence of processing that makes use of the document.

The rule information storage part 102 has a role to store rule information that specifies how to weight a certain keyword.

The keyword acquisition part 103 has a role to acquire information on documents to be processed (at least either one of the use history information and the attribute information of the documents) as a plurality of keywords (i.e., to acquire a plurality of keywords from among pieces of access history information constituting the collection). In addition, the keyword acquisition part 103 further has a function to divide the acquired keywords according to a morphological analysis or the like, as required. A keyword frequency list to be described later is prepared in the keyword acquisition part 103.

The user identification part 104 has a role to identify a user who requests keyword extraction prior to the keyword weighting processing (to be described later in detail) in the below-mentioned weighting part 105.

The weighting part 105 respectively weights the plurality of keywords (divided keywords if divided) acquired in the keyword acquisition part 103 based on the rule information stored in the rule information storage part 102.

The specific keyword extraction part 106 has a role to extract a specific keyword (significant keyword) from the plurality of keywords thus acquired, based on the weighting of the plurality of keywords respectively performed in the weighting part 105.

The control part 107 is comprised of a CPU or the like, and has a role to control the respective parts (e.g., those including the keyword acquisition part 103 through the specific keyword extraction part 106) in the keyword extraction apparatus according to this embodiment.

The storage part 108 is comprised of a ROM, a RAM or the like, and has a role to store programs, etc., that are executed in the control part 107 so as to perform processing in the apparatus. The unillustrated display part is composed of a touch panel display or the like, is connected to the control part 107 for communication therewith, and has a role to make operational inputs, a screen display and the like in the keyword extraction apparatus.

Although the data storage part 101, the rule information storage part 102 and the storage part 108 are illustrated herein as being arranged inside the keyword extraction apparatus, the present invention is not limited to this. For example, it can be constructed such that at least one of the data storage part 101, the rule information storage part 102 and the storage part 108 is arranged in external equipment which is connected to the apparatus for commutation therewith.

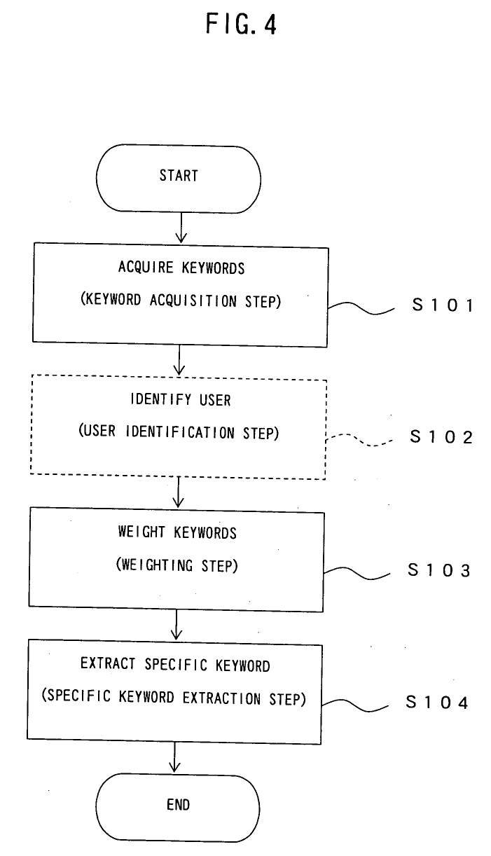

Next, reference will be made to the flow of processing in the keyword extraction apparatus according to this embodiment while using a flow chart of FIG. 4. The respective steps of the processing in the keyword extraction apparatus as described below are achieved by letting a keyword extraction program stored in the storage part 108 be executed by the control part 107.

First of all, a plurality of keywords are acquired from among pieces of access history information that constitute a collection of pieces of access history information to a document (keyword acquisition step) (S101).

Then, a user who is intended to perform keyword extraction is identified by the user identification part 104 (user identification step) (S102).

Subsequently, the plurality of keywords acquired in the keyword acquisition step are weighted based on prescribed rule information (weighting step) (S103).

Thereafter, a specific keyword is extracted from among the plurality of keywords acquired in the keyword acquisition step based on the weights assigned to the plurality of keywords, respectively, in the weighting step (specific keyword extraction step) (S104).

Thus, the processing for extracting a keyword that characterizes the collection of pieces of access history information with respect to the document is performed. Here, note that the user identification step (S102) is not always performed in the processing of the keyword extraction apparatus according to this embodiment, but carried out as required (details will be described later).

In the following, the details of the processing in the respective steps as illustrated in the flow chart of FIG. 4 will be described.

(Keyword Acquisition Step)

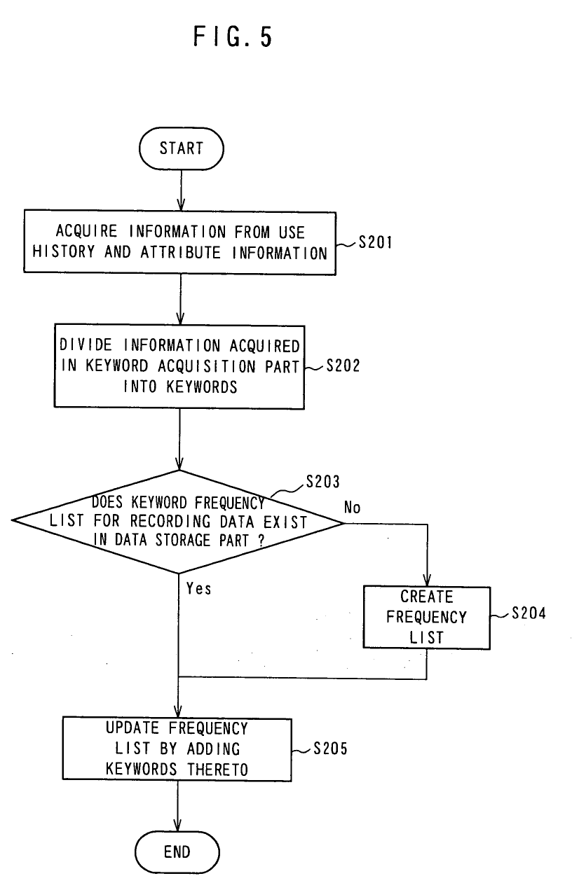

FIG. 5 is a flow chart that illustrates the keyword acquisition step (S101).

An attention is focused on a collection of pieces of information brought together beforehand by a user or system under a certain intention thereof (hereinafter referred to as a case) among the information related to the use history and the attribute information of the documents managed by the data storage part 101. As for how to bring or organize pieces of information together into the case, there can be considered various cases such as for each operation content, each date, each group to which users belong, each user, etc., of the documents.

First of all, various pieces of information available as keywords are acquired by the keyword acquisition part 103 from among the use history information related to a document group constituting a certain case and the attribute information related to that document group (S201).

Here, when some of the keywords thus acquired are each composed of a plurality of words, each of those keywords is divided, as required, into a plurality of keywords according to a morphological analysis or the like in the keyword acquisition part 103 (S202). For example, in case where a document title contained in a certain case is the one “<Request> a request for cooperation with the evaluation of history analysis systems”, it is divided into a plurality of keywords such as “<Request>”, “a request for”, “cooperation with the evaluation”, “of”, and “history analysis systems”.

Then, the keywords acquired in the above-mentioned steps (S201, S202) are registered in a frequency list in the keyword acquisition part 103. For those keywords which have already been listed in a frequency list of the case which is stored in the data storage part 101 and for which keyword extraction is currently made (S203, Yes), the values of the use frequencies of those keywords are updated S205), whereas for those keywords which are not listed in the frequency list (S203, No), a frequency list for those unlisted keywords is created (S204).

Specifically, the frequency list is a list which stores, by focusing attention on a collection of pieces of document use history information (case), the keywords which have been acquired from the use history information and attribute information of the documents constituting the collection, as well as the use frequencies of the respective keywords in the collection.

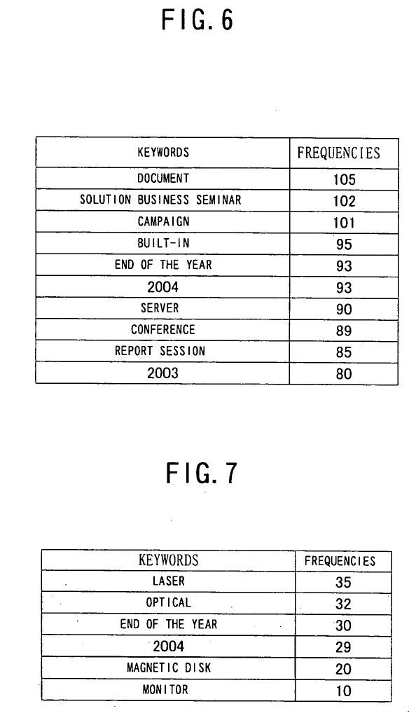

FIG. 6 is a view that illustrates the content of a frequency list that has been created for a collection of pieces of information classified according to “the work or task contents of documents (used in the works or tasks for the same purpose)”. FIG. 7 is a view that illustrates the content of a frequency list that has been created for a collection of pieces of information classified according to work or task contents different from those of FIG. 6. For example, in a “task to investigate the trend of competitors through the Internet”, or in “tasks to prepare patent specifications in fiscal year 2004”, etc., document use history information or the like used in each task belong to its case.

In addition, the following two cases are considered. That is, in one case, those keywords which have been divided from the information acquired from various pieces of history information are classified to create frequency lists for each user, each group and each time duration or period, and in the other case, pieces of history information collected or brought together for each user, each group and each time duration or period are used so that each piece of the history information is divided into keywords, thereby creating a corresponding frequency list. In this manner, a variety of types of frequency lists can be created for each user, shared history information (for a plurality of pieces of use history existing together), each group, or within a specified time duration.

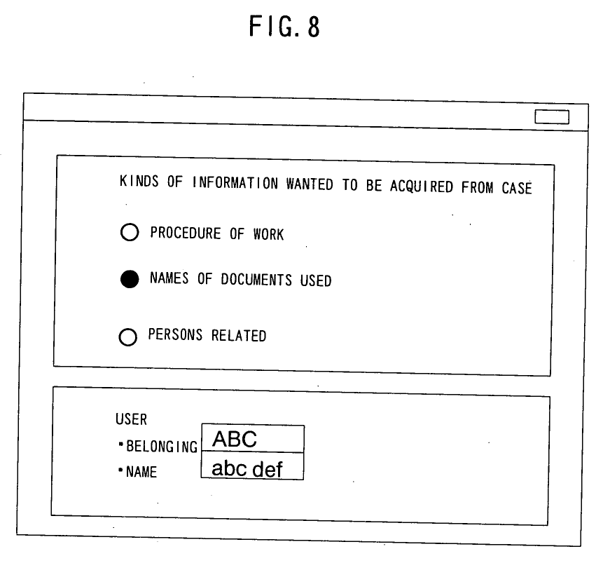

Although in the above-mentioned keyword acquisition processing (S201), it is constructed to acquire all the keywords that can be acquired from the case, the present invention is not limited to this. That is, it becomes possible for the user extracting keywords to set, on a setting screen displayed in the unillustrated display part, the kinds of information, based on which the keywords are acquired (i.e., what kind of keywords are wanted to be acquired) (FIG. 8). Here, it is constructed such that the user can limit the words to be acquired as keywords by selecting contents such as “a work or task procedure”, “the names of the documents used”, and “related persons”.

The contents thus set are stored in the storage part 108 in forms such as files, registries or the like by which the set contents can be found or seen later.

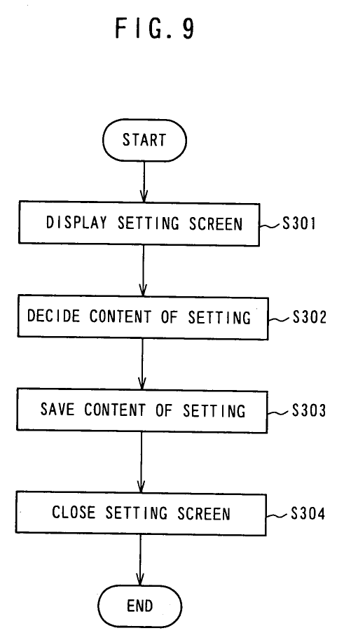

FIG. 9 is a flow chart that illustrates the flow of processing when such a setting is carried out.

First of all, a setting screen shown in FIG. 8 is displayed on the unillustrated display part (S301). Then, an arbitrary setting operation is carried out by the user (extraction reference information setting step), and when the content of the setting is determined and fixed (S302), the setting content is stored in the storage part 108 (S303). Thereafter, the setting screen displayed on the unillustrated display part is closed (S304).

Here, note that the present invention is not limited to above-mentioned examples, but it is possible to make setting in such a manner that the contents of keywords to be extracted are limited by the work or task environment under which the user is intended to perform keyword extraction processing, or the contents of keywords to be extracted are limited for each user by acquiring, from the system, information (e.g., account information, etc.) on the user who is intended to perform keyword extraction processing by means of the user identification part 104. That is, the configuration is such that it is possible to set how to weight the keywords acquired from among pieces of access history information with respect to the documents in accordance with the method of utilization thereof, the information to be wanted, the environment under which the keywords are to be presented.

(Weighting Step and Specific Keyword Extraction Step)

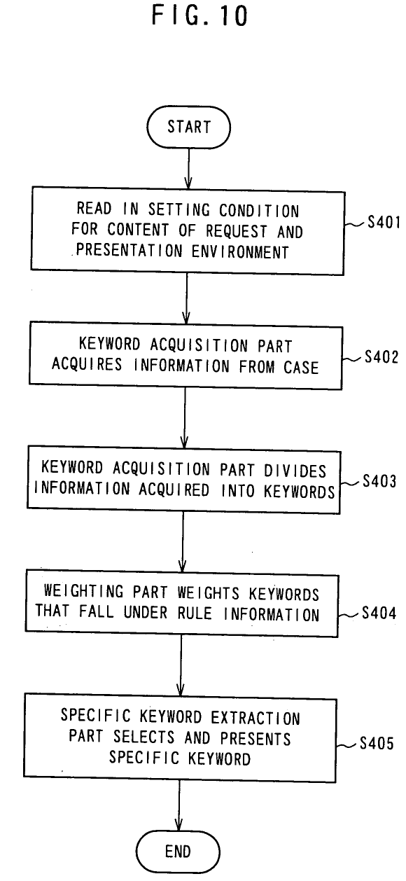

FIG. 10 is a flow chart that illustrates the weighting step (S103) and the specific keyword extraction step (S104).

The control part 107 lets the weighting part 105 acquire rule information, etc., stored in the weighting part 105 (S401), and perform weighting processing (S404) on the keywords that have been acquired in the keyword acquisition part 103 (S402) and further divided as required into appropriate keywords (S403) (weighting step).

Specifically, the rule information storage part 102 stores therein, as rule information, “information on weighting with respect to user requests”, “information on weighting according to use methods”, “information on weighting according to presentation environments”, and so on. These pieces of rule information have been set as default, or set on the above-mentioned setting screen or the like by the user prior to the keyword extraction processing.

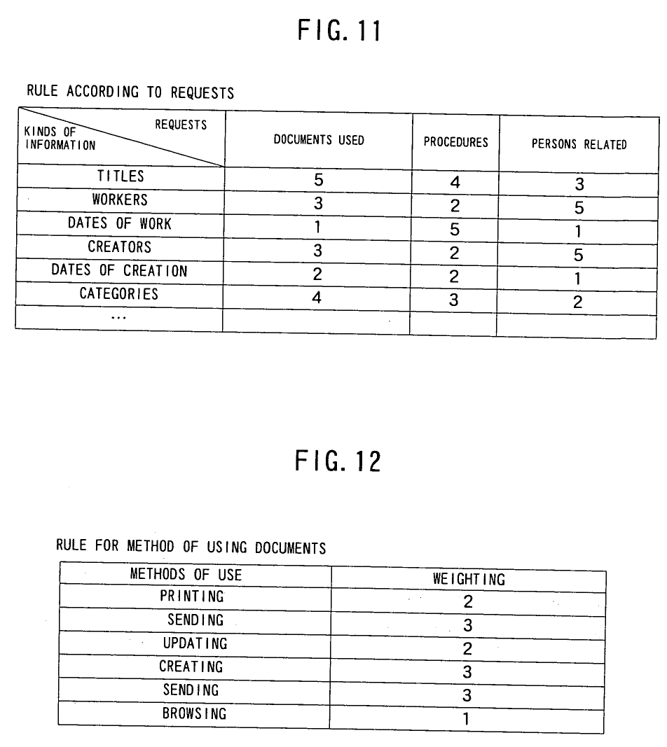

The “information on weighting with respect to user requests” is rule information used for changing the weights of keywords in accordance with what keywords the user wants to be extracted from among the case (corresponding to an extraction reference or criterion). For example, the significance of a keyword acquired from the case will be different between when “the user wants to know the procedure of a work or task” and when “the user wants to know what documents have been used”, and when “the user wants to know who relates to the work or task. Thus, a weighting rule according to user requests is defined in the “information on weighting with respect to user requests” (see FIG. 11). In this figure, settings are made in such a manner that, for example, in case where the user wants to evaluate the keywords related to the “documents used” as significant, information on the “titles of documents” is weighted as significant (e.g., the weight is 5), whereas information having a low relation to the “documents used” such as the “dates of work or task” is weighted lightly (e.g., the weight is 1). That is, the reference or criterion for “characteristic keywords” is changed in accordance with the information the user wants to acquire.

Specifically, the keyword extraction apparatus according to this embodiment includes an extraction reference information setting step for setting a reference or criterion for extraction of keywords on the above-mentioned setting screen. As a result, the configuration becomes such that it is possible to make use of the frequency of occurrences of keywords that have been obtained within the range of the access history information determined based on the extraction reference information thus set. Here, as the range of the access history information determined based on the extraction reference information, there are exemplified “keywords within a category set as the extraction reference”, “keywords out of the category set as the extraction reference”, or the like.

The “information on weighting according to use methods” is rule information for weighting document attribute information and document use history information related to the methods of using documents such as “browsing or viewing”, “sending”, “updating”, “creating” and “printing”. This is because attention has been focused on the fact that the documents used for “printing ”, “sending”, or the like have a greater use intention of the user (or system) in the case than the documents used for “browsing or viewing” alone do.

For example, it can be estimated that if certain documents are printed from among a plurality of documents which have been browsed, the level of significance in the work or task of the documents used for printing is higher than that of the documents which have been just browsed or viewed. Thus, the weighting rule for weighting pieces of information related to documents (keywords) based on the use methods, access methods, or the like of the documents is defined in the “information on weighting according to use methods” (see FIG. 12).

The “information on weighting according to presentation environments” is rule information for performing weighting in accordance with the environments under which keywords are presented. Even with the same keyword, whether it is a characteristic keyword or a general keyword becomes different depending upon whom it is to be exhibited to, or under what environment (system environment, kinds of works or businesses) it is to be presented.

The weighting part 105 in this embodiment performs the keyword weighting processing based on the “information on weighting according to presentation environments” stored in the rule information storage part 102 and a keyword frequency list (the frequency of occurrences of the acquired keywords in the access history information that constitutes the collection) stored in the data storage part 101. The frequency list is, for example, one which lists the use frequencies (occurrences frequencies) of the keywords contained in the use history information of a certain user (or a plurality of users) or in the document attribute information. The kinds can include, besides this, other various collections such as each group, each time duration, each department, each division, and so on.

Thus, it is possible to weight the keywords by using a frequency list suitable for an environment under which the information is presented, while taking into consideration such an environment from the user information, account information or the like acquired (identified) by the user identification part 104 (i.e., weighting can be done on the basis of the result of identification carried out in the user identification step).

It is also possible to grasp, from a keyword frequency list, frequently used keywords, general keywords, infrequently used keywords and the like in a range to which the frequency list is applied. As a result, a determination can be made that those keywords which appear at a very high frequency in an environment under which the keywords are to be presented are generally used keywords and hence are not suitable for representing the characteristic of the case (i.e., have a low significance). That is, it is possible to weight a plurality of acquired keywords on the basis of the frequencies of occurrences of the keywords acquired in access history information older than the one constituting the collection.

For example, when a user wants to extract a significant keyword (specific keyword) in a case B (in the use history) and present them to a person A, the keywords having high frequencies in the keyword frequency list for the person A are determined to be general keywords, and hence the priorities for these keywords are accordingly lowered upon extracting significant keywords. That is, a filter (rule information) is dynamically prepared in accordance with the person to whom the information is to be presented, so that general keywords are removed from among the extracted keywords.

For example, when keywords are to be presented to the both of person A and person B, weighting can be carried out by making use of the both keyword frequency lists for the persons A and B. In this manner, in the “information on weighting according to presentation environments”, there is beforehand defined rule information for performing weighting according to presentation environments by appropriately combining a plurality of kinds of frequency lists in accordance with the persons to whom and/or the environments under which keywords are to be presented.

Although the information on weighting according to presentation environments can be used by making reference to frequency lists as required and by appropriately combining them in an appropriate manner, frequency lists for such combinations can be beforehand prepared and stored in the data storage part 101.

Also, it is possible to store in the rule information storage part 102 rule information that has been beforehand prepared by appropriately combining a plurality of kinds of pieces of rule information (e.g., “information on weighting according to presentation environments”, “information on weighting according to use methods”, and so on) with one another. In this case, it is unnecessary to perform the processing of making reference to a plurality of pieces of rule information, thereby making it possible to contribute to an improvement in the efficiency of the overall processing.

The control part 107 controls the specific keyword extraction part 106 in such a manner that the specific keyword extraction part 106 is made to extract significant keywords from among a keyword group in which weighting is carried out by the weighting part 105 (specific keyword extraction step) (S405).

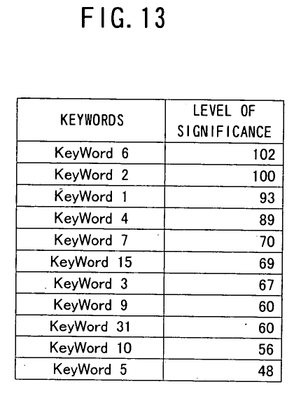

In the specific keyword extraction part 106, keywords of higher priorities (those being heavily weighted) among a group of keywords assigned with the order of priorities in the weighting part are extracted. Here, as methods for extracting significant keywords, there are considered various ones such as a method for displaying some of higher ranked keywords that are heavily weighted on the screen of the unillustrated display part in a list representation (see FIG. 13), a method for displaying all the keywords on the screen in the order of weights (e.g., providing a screen display of them in such manner that the heavier the weight of a keyword, the higher the level of significance thereof becomes), a method for displaying only keywords of significance levels higher than a predetermined significance level (weight), a method for displaying, as a keyword, character strings comprising some heavily weighted keywords connected with one another on a screen, and so on.

In addition, significant keywords, when extracted, can also be weighted or selected based on the setting information that has been set on the above-mentioned setting screen or the like and stored in the storage part 108, according to relevant rule information stored in the data storage part 101. Thus, the extraction of a specific keyword (i.e., a predetermined keyword based on the default or user setting) is performed.

Here, as the handling of insignificant keywords (i.e., keywords lower than a certain significance reference), there are enumerated the following cases.

(1) Insignificant keywords are not acquired from the beginning in the keyword acquisition part in consideration of the document use history information and the attribute information.

(2) The keywords of low significance levels are excluded in the keyword acquisition part 103, the weighting part 105 and the specific keyword extraction part 106, respectively, by the time when significant keyword extraction processing is carried out.

(3) The acquired keywords are not removed until significant keyword extraction processing is carried out in the specific keyword extraction part 106, so that even keywords, possibly, of low significance levels are subjected to weighting processing.

Although in this embodiment, the functions for implementing the present invention are recorded beforehand in the interior of the keyword extraction apparatus (the storage part 108), the present invention is not limited to this but similar functions can be downloaded into the apparatus via a network, or a computer-readable recording medium storing therein similar functions can be installed in the apparatus. Such a recording medium can be of any form, such as for example a CD-ROM, which is able to store programs and which is able to be read out by the apparatus. In addition, the functions to be obtained by such preinstallation or downloading can be achieved through cooperation with an OS (operating system) or the like in the interior of the apparatus.

Although in the above-mentioned embodiment, there has been shown an example of performing specific keyword extraction processing after the creation processing of frequency lists, the present invention is not limited to this, and it is also possible to concurrently perform the frequency list creation processing and the specific keyword extraction processing in parallel to each other.

As described above, the keyword extraction apparatus according to this embodiment can focus attention to a certain collection in the use history of documents, acquire information related to the documents therein, store the information thus acquired in the specific keyword extraction part, divide it into keyword-level (relatively short) character strings, and extract therefrom a significant keyword that characterizes the collection. As an element to decide whether a certain keyword is a significant keyword, keywords are weighted in consideration of the use methods of the documents (printed, sent, updated, browsed, etc.) (significance levels thereof are adjusted). A mechanism is provided which can decide, when a user acquires information from a collection of document use histories, the information to be acquired depending upon what information the user wants to acquire from the collection, and a setting screen therefor is also provided. In the process of selecting a “specific keyword”, it is necessary to exclude general keywords, and at this time, whether general keywords or not varies depending upon an environment such as whom the information is presented to, etc.

As described above, according to this embodiment, in characterizing a collection such as document use history information or the like, it becomes possible to extract a specific keyword thereby to easily grasp the content of the collection.

In addition, it is configured so as to handle, as objects from which keywords are to be acquired, information that does not depend on the contents of documents, such as document use history information, document attribute information and so on. With such a configuration, even when the collection includes documents that do not contain any character information in their contents, keywords related to the documents if significant can be reflected on the keyword extraction result.

In the past, TF (Term-Frequency) weighting, IDF (Inverse-Document-Frequency) weighting and so on have been known, but in this embodiment it becomes possible to perform weighting in consideration of how to use documents (use methods), what keywords a user wants to know, whom the keywords are presented to, etc. Moreover, it also becomes possible to classify documents into document groups based on the attributes, etc., of the documents. Of course, it is needless to say that this embodiment can be made use of in combination with the above-mentioned TF weighting or IDF weighting. As a result, keywords that are nearly expected can be extracted.

As described in detail in the foregoing, according to the present invention, it is possible to extract an appropriate keyword to characterize a collection of pieces of access history information without depending on the contents of documents related to the collection of access history information.

What is claimed is:

1. A keyword extraction apparatus for performing processing of extracting a keyword that characterizes a collection of pieces of access history information with respect to documents, said apparatus comprising:
a keyword acquisition part that acquires a plurality of keywords from among said pieces of access history information constituting said collection;
a weighting part that weights said plurality of keywords acquired based on prescribed rule information; and
a specific keyword extraction part that extracts a specific keyword from among said plurality of keywords acquired based on the weights assigned to said plurality of keywords, respectively, in said weighting part.

2. The keyword extraction apparatus according to claim 1, wherein said weighting part weights said plurality of acquired keywords on the basis of the frequencies of occurrences of said keywords acquired in said pieces of access history information constituting said collection.

3. A keyword extraction program for making a computer execute processing of extracting a keyword that characterizes a collection of pieces of access history information with respect to documents, said program adapted to make said computer execute:
a keyword acquisition step of acquiring a plurality of keywords from among said pieces of access history information constituting said collection;
a weighting step of weighting said plurality of keywords acquired based on prescribed rule information; and
a specific keyword extraction step of extracting a specific keyword from among said plurality of keywords acquired based on the weights assigned to said plurality of keywords, respectively, in said weighting step.

4. The keyword extraction program according to claim 3, wherein said weighting step weights said plurality of acquired keywords on the basis of the frequencies of occurrences of said keywords acquired in said pieces of access history information constituting said collection.

5. The keyword extraction program according to claim 4, wherein access histories constituting said collection are associated with a plurality of users.

6. The keyword extraction program according to claim 4, further comprising an extraction reference information setting step of setting an extraction reference for keywords to be extracted, wherein said weighting step weights said plurality of acquired keywords on the basis of said frequencies of occurrences of said keywords acquired in a range of said pieces of access history information determined based on said set extraction reference information.

7. The keyword extraction program according to claim 4, wherein said collection of pieces of access history information is constructed based on either of user names, the contents of accesses, and the time point at which said pieces of access history information are generated, and said weighting step performs weighting based on the keywords acquired in said keyword acquisition step and information on the frequencies of occurrences of said keywords associated with said collection.

8. The keyword extraction program according to claim 3, wherein said access history information includes information on the contents of uses of the documents, and said weighting step weights keywords acquired from among pieces of access history information with respect to the documents based on the contents of uses thereof.

9. The keyword extraction program according to claim 3, wherein said weighting step weights said plurality of acquired keywords on the basis of the frequencies of occurrences of said keywords acquired in access history information older than said pieces of access history information constituting said collection.

10. The keyword extraction program according to claim 3, further comprising a user identification step of identifying a user who is intended to perform keyword extraction, wherein said weighting step performs weighting based on the result of identification in said user identification step.

11. The keyword extraction program according to claim 3, wherein said specific keyword extraction step performs keyword extraction in such a manner that the heavier the weights assigned to said plurality of keywords in said weighting step, the higher are the significance levels of the keywords.

12. The keyword extraction program according to claim 3, wherein said specific keyword extraction step provides a screen display of said acquired keywords in a ranked order based on the weights assigned to said plurality of keywords, respectively, in said weighting step.

13. The keyword extraction program according to claim 3, wherein said keyword acquisition step acquires a plurality of keywords from among pieces of access history information constituting said collection by using a morphological analysis.

14. The keyword extraction program according to claim 3, wherein said access history information includes at least one of attribute information of the documents related to said access history information, information on the titles of said documents, and information on time points at which said documents were accessed, the contents of accesses to said documents, and users who made said accesses.
